(19) United States
(12) Patent Application Publication
(10) Pub. No.: US 2016/0170376 A1
(43) Pub. Date: Jun. 16, 2016

(54) EXTERNAL ELEMENT WITH A PRESSURE SENSOR

(71) Applicant: The Swatch Group Research and Development Ltd, Marin (CH)

(72) Inventors: Nicolas FRANCOIS, Neuchatel (CH); Stewes BOURBAN, Chabrey (CH); Juliette MULLER, La Neuveville (CH)

(73) Assignee: The Swatch Group Research and Development Ltd, Marin (CH)

(21) Appl. No.: 14/962,807

(22) Filed: Dec. 8, 2015

(30) Foreign Application Priority Data
Dec. 15, 2014 (EP) 14198041.7

(51) Int. Cl. G04B 47/06; G01L 11/02

(52) U.S. Cl. CPC G04B 47/066; G01L 11/02

(57) ABSTRACT

The present invention concerns an external timepiece element including a frame made of a first material, said external element further including at least one pressure or altitude sensor, characterized in that said pressure or altitude sensor is formed of at least one disc or plate, said disc or plate being formed of or coated with a binder and a piezochromic pigment, said piezochromic pigment being selected to react at a specific pressure, so that said pigment changes from a first colour to a second colour when said specific pressure is reached.

This application claims priority from European patent application 14198041.7 filed Dec. 15, 2014, the entire disclosures of which is hereby incorporated by reference.

The present invention relates to an external timepiece element including a frame made of a first material, said external element further including at least one pressure sensor.

### BACKGROUND OF THE INVENTION

There are known portable objects, such as watches, equipped with pressure sensors for altitude detection. These pressure sensors may take the form of piezoelectric sensors used to convert stress, air or water pressure into an electrical signal which will be analysed by a microcontroller.

One drawback of these piezoelectric sensors is that they have a lag time in the display of pressure and therefore altitude. A microelectronic system and therefore an energy source is required for operation.

Another known possibility consists of a diving watch which allows water to enter a channel or conduit actually inside the sapphire watch crystal, which makes it possible to measure the depth reached. This method relies on the law of physics known as Bolye-Mariotte's law. If the pressure increases, the volume of gas decreases. The more water enters the gauge, the more the air inside is compressed. The contact point between the water and air indicates the depth on a scale at the periphery of the dial.

One drawback of this solution is that there is a risk of drops of water remaining trapped in the conduit creating an air bubble and distorting the mechanism, thereby making the depth reading unreliable.

Another possibility consists in using a closed capillary filled with a fluid located in a reservoir connected to the capillary. This closed circuit is inserted between two plates so that, as a function of pressure, the reservoir is compressed causing the fluid to move in the capillary, which allows the depth or altitude to be determined.

However, this solution, which is complex to implement, requires a fluid having physical properties that limit decorative possibilities.

### SUMMARY OF THE INVENTION

The invention concerns an external element that overcomes the aforementioned prior art drawbacks by proposing a portable object capable of providing an altitude indication in a readable and reliable manner.

To this end, it is an object of the invention to provide an external timepiece element including a frame made of a first material, said external element further including at least one pressure or altitude sensor, characterized in that said pressure or altitude sensor is formed of at least one disc or plate, said disc or plate being formed of or coated with a binder and a piezochromic pigment, said piezochromic pigment being selected to react at a specific pressure sensed at the surface of the disc or plate, so that said pigment changes from a first colour to a second colour when said specific pressure is reached.

In a first advantageous embodiment, said pressure sensor is formed of a plurality of discs or plates, each disc or plate reacting at a specific pressure peculiar thereto.

In a second advantageous embodiment, said discs or plates all have the same first colour.

In a third advantageous embodiment, said discs or plates all have the same second colour.

In a fourth advantageous embodiment, said discs or plates are devised such that their second colour can produce shading when they have all changed from the first colour to the second colour.

In a fifth advantageous embodiment, said pressure sensor makes it possible to measure a positive altitude with respect to sea level.

In a sixth advantageous embodiment, said pressure sensor makes it possible to measure a negative altitude with respect to sea level.

In another advantageous embodiment, said pressure sensor can measure an underwater depth.

In another advantageous embodiment, the disc or plate takes the form of an ink or paint or lacquer deposited on the frame, said frame being hollow.

In another advantageous embodiment, the disc or plate takes the form of an insert formed of a hollow body impermeable to water and air, said hollow body being coated with said piezochromic pigment.

In another advantageous embodiment, the disc or plate takes the form of an insert formed of a hollow body impermeable to water and air, said piezochromic pigment being dispersed in the material forming said body.

In another advantageous embodiment, the frame includes at least one hollow in which the disc is arranged.

In another advantageous embodiment, the frame is a bezel.

In another advantageous embodiment, the frame is a crystal.

In another advantageous embodiment, the frame is the middle part of a watch case.

In another advantageous embodiment, the frame is a watchband.

In another advantageous embodiment, the watchband includes two strands made of plastic material, said altitude sensor being arranged on at least one of the two strands.

In another advantageous embodiment, the watchband includes a plurality of links hinged to each other, said altitude sensor being arranged on at least one link.

In another advantageous embodiment, said watchband is closed by a clasp with a deployant buckle, said altitude sensor being arranged on said clasp.

In another advantageous embodiment, the frame is a crown.

In another advantageous embodiment, said piezochromic pigment is coupled to a luminescent pigment to emit a more intense colour.

### BRIEF DESCRIPTION OF THE DRAWINGS

The advantages of an external element of this type will appear clearly upon reading the following description and on examining the illustrative drawing, in which:

FIGS. 1 and 2 show schematic views of a timepiece according to the present invention.

FIGS. 3 and 4 show schematic views of a bezel forming the external element according to the present invention.

FIGS. 5 and 6 show schematic views of a crystal forming the external element according to the present invention.

FIG. 7 is a schematic view of a case middle forming the external element according to the present invention.

FIG. 8 is a schematic view of a watchband strand forming the external element according to the present invention.

FIG. 9 shows a schematic view of links of a watchband strand forming the external element according to the present invention.

FIGS. 10 to 12 show schematic views of a watchband clasp forming the external element according to the present invention.

### DETAILED DESCRIPTION

The present invention concerns an external element 1 of a timepiece or watch 100.

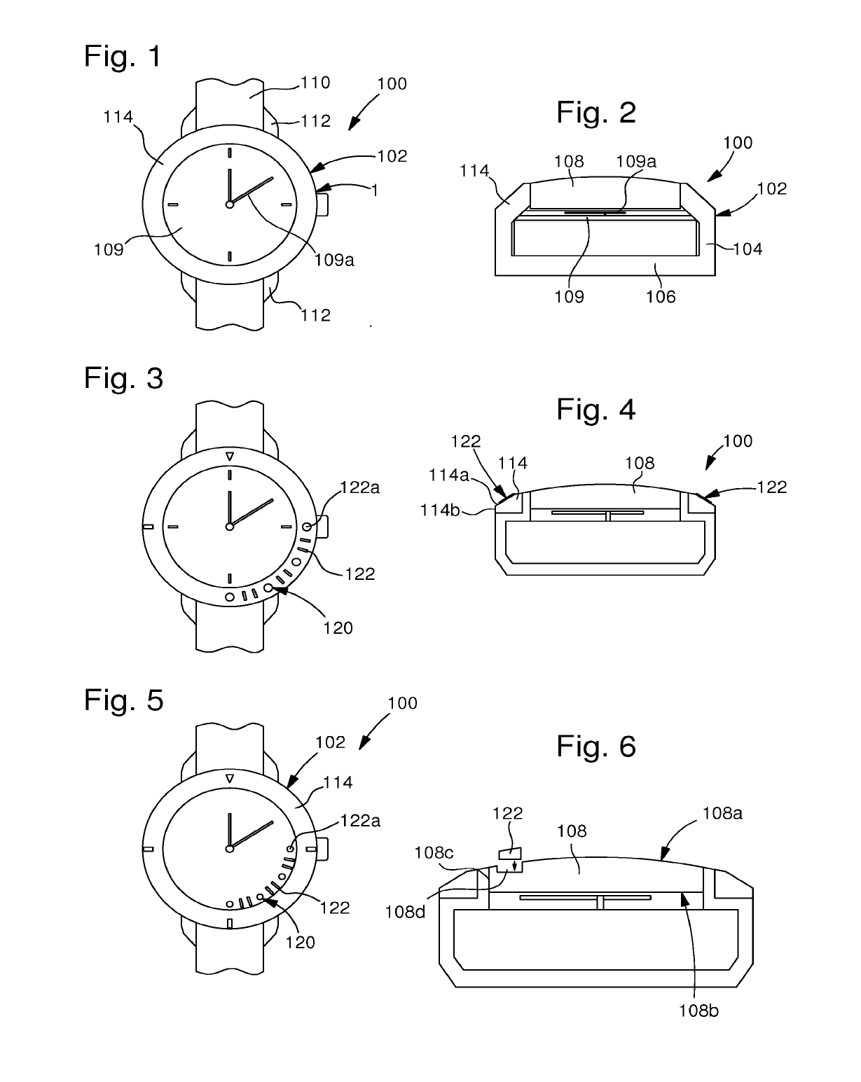

Timepiece 100, seen in FIGS. 1 and 2 is, for example, a wristwatch and includes a case 102. This case is formed by a case middle 104 closed by a back cover 106 and a crystal 108. The timepiece may include a dial 109 and display means 109a. This timepiece also includes a watchband 110. The latter is fixed to the case middle via two pairs of horns 112. The watchband may be formed of two strands, each strand being fixed to a pair of horns and connected to the other strand via a clasp.

External element 1 includes a frame made of a first material. This first material may be, for example, a metallic, ceramic, composite or plastic material.

At least one altitude sensor 120 is arranged on said frame. Pressure or altitude sensor 120 is used to enable the user to visualise the level of his location with respect to a reference. Indeed, it is possible to envisage the altitude sensor permitting the display of a positive altitude, i.e. positive with respect to sea level, but also a negative altitude, i.e. below sea level.

Advantageously according to the invention, the altitude sensor includes at least one piezochromic disc or plate 122. This piezochromic disc or plate arranged on a hollow support impermeable to water and air, whose cavity is at a known pressure PRef, or is formed of a hollow body impermeable to water and air, whose cavity is at a known pressure PRef. The disc or plate is also formed of a piezochromic pigment dispersed in a matrix. This matrix is a binder acting as support for the pigment. This configuration makes it possible for the piezochromic pigment to perceive a difference in pressure between the known pressure PRef and the external pressure sensed.

Such a piezochromic pigment has a first colour at ambient pressure and changes colour to have a second colour when the pressure reaches a value specific to said pigment. Since depth and altitude are linked to pressure, it is possible to have an altitude indication above or below sea level. Thus, pressure increases with depth and decreases with altitude.

This feature makes it possible to visually indicate the crossing of a pressure threshold.

In a preferred embodiment, the altitude sensor can display an altitude scale. To achieve this, the altitude sensor includes a plurality of piezochromic discs. Each piezochromic disc includes a pigment reacting at a specific pressure. Consequently, each disc changes colour when a specific pressure is reached. In order to provide an altitude scale, the specific pressures of the discs will be either increasing or decreasing pressures. Thus, when the user carrying the portable object gains altitude, the discs gradually change colour providing a visual indication. These discs 122 may be adhesive bonded to each other or separate.

In a preferred variant, the various discs forming the altitude scale all have a first colour, i.e. an identical colour at rest. This means that at sea level altitude, all the discs have the same colour.

In another preferred variant, the various discs forming the altitude scale all have a second colour, i.e. an identical colour when their specific threshold is reached. This means that at a maximum measurable altitude, all the discs will have the same colour.

In another preferred variant, the various discs forming the altitude scale all have an identical first colour but are made such that they do not all have an identical second colour in order to allow shading. More specifically, the discs are devised such that, when they form an altitude scale, the first discs to change colour have a second lighter colour than the last discs to change colour. For example, the first discs become yellow and the last become red. This provides a double indication: the user not only knows that the depth or altitude is increasing since the number of discs changing colour is increasing, but he also knows that he is close to a maximum altitude or depth since the colour varies and becomes increasingly dark.

It will be understood here that the piezochromic pigment is of the reversible type. This means that when the pigment reaches or exceeds a specific pressure threshold, it changes colour passing from a first colour to a second colour. However, this also means that when the pressure passes below the specific threshold again, the pigment changes from the second colour to the first colour.

In an example embodiment of said piezochromic pigment, the latter is used in dispersion in a binder in a weight ratio of 0.01 and 5%. The pigment includes in a non-limiting manner;
Triaryl imidazole dimers of Bis-2,4,5-triaryl imidazoles having one or more substitutents groups selected from aryl groups such as phenyl. p-tolyl, p-chlorophenyl or p-anisyl

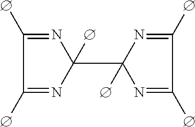

The preferred compounds are: 2,2′,4,4′,5,5′-hexaphenyle bisimidazole; 2,2′,4,4′,5,5′-hexa-p-tolyl bisimidazole; 2,2′,4,4′,5,5′-hexa-p-chlorophenyl bisimidazole; le 2,2′-di-p-chlorophenyl-4,4′,5,5′ tetraphenyl bisimidazole; le 2,2′-di-p-Anisyl-4,4′,5,5′-tetraphenyl bisimidazole; and 2,2′-di-p-tolyl-4,4′,5,5′-tetraphenyl bisimidazole.
Bistetraaryl pyrrole Bistetra phenyl pyrrole

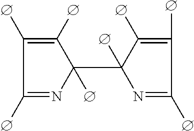

Bianthrones: Δ10,10′-bianthrone; 2,4,2′,4′-tetra ethyl bianthrone Xanthylidene anthrone.

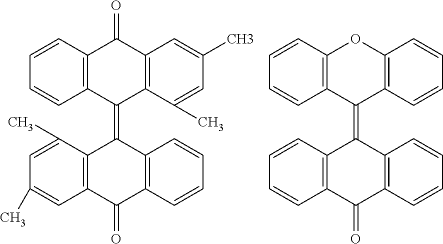

Dixanthylene.
Helianthrone.
Mesonaphthobianthrone.

The matrix used for pigment dispersion may be of various types.

A first matrix category includes inks, lacquers and paints. This matrix consists of a polymeric binder mixed with at least one solvent, a plasticiser and a dispersing agent. Such a matrix may be a polyurethane, acrylic, polysilane family, silicone, epoxy, polyamide, cellulosic system or any other polymeric system combining the peculiar aesthetics and resistance required for timepiece components.

A second matrix category includes thermoplastic granules. This matrix consists of a resin mixed with at least one dispersing agent and a plasticiser.

A third matrix category includes a rubber mixture. This matrix consists of an elastomer mixed with at least charges, a dispersing agent and a vulcanization system.

A fourth matrix category includes thermosetting mixtures. These mixtures consist of a liquid resin mixed with at least one dispersing agent.

The second, third and fourth categories can thus produce piezochromic discs in the form of moulded inserts; the discs can then be subsequently assembled to components (over-moulding, adhesive bonding, screwing techniques may be used). These categories can also produce moulded plastic components incorporating the piezochromic disc by multi-material piezochromic injection.

These categories allow the discs to be used as a coating to form a piezochromic disc or a decoration, such as for example, a series of piezochromic discs made by printing, by silk screen printing an altitude scale on the frame, which is hollow and impermeable in order to have a known pressure PRef. This configuration makes it possible for the piezochromic pigment to perceive a difference in pressure between the known pressure PRef in the frame and the external pressure sensed.

These categories can also produce a disc in the form of an insert, i.e. a hollow body impermeable to water and air, whose cavity is at a known pressure PRef. This body may be formed of a material including the piezochromic pigments or be coated with an ink including said pigments. This coating may be a lacquer or a thin film deposition. This configuration makes it possible for the piezochromic pigment to perceive a difference in pressure between the known pressure PRef in the hollow body and the external pressure sensed.

The material used may be an organic or metallic or inorganic, transparent or opaque material, such as, for example, plastic or a resin or a glass.

In one example, the disc is made of poly(methyl methacrylate) also known as PMMA. This disc is formed of a double shell assembled and made impermeable by ultrasound welding. This double shell is then coated by spraying a 50 μm deposition of a thermochromic polyurethane lacquer containing a dispersion of piezochromic pigments. The piezochromic pigment represents 2.5% by weight of the mixture.

In a first implementation, the external element is a bezel 114 as see in FIGS. 3 and 4. This bezel 114 may be a rotating bezel or a fixed bezel. In the case of a fixed bezel, the bezel may be a ring secured to the case middle so that it cannot rotate, or be directly incorporated in case middle 104 and thereby form a case middle-bezel.

Such a bezel 114 has an upper wall 114a which is the face seen by the user and a vertical wall 114b allowing the user to rotate the bezel in the case of a rotating bezel.

In this embodiment, piezochromic pigment discs 122 are arranged on the upper wall 114a acting as the visible face.

In the case where discs 122 take the form of an ink or paint, these discs are silk-screen printed on said upper wall; the bezel is hollow. A scale may also be silk-screen printed to associate a number indication with these piezochromic discs. Of course important values, such as 0, 100 m, 200 m could also be displayed by different discs 122a.

In the case where the discs take the form of inserts, upper wall 114a of bezel 114 includes hollows (not shown). The number of hollows is identical to the number of inserts. The inserts can then be placed and secured in the hollows by adhesive bonding, for example. However, it is also possible to over-mould the inserts in the hollows. This thus produces a bezel having a bimaterial appearance when a metal bezel has rubber inserts for example.

Of course, it is possible to have several altitude sensors 120 on the bezel. For example, a first sensor could extend over the bezel in an arc of a circle from the 9 o'clock position on the hour-circle to the 3 o'clock position on the hour-circle. A second sensor could extend over the bezel in an arc of a circle from the 3 o'clock position on the hour-circle to the 9 o'clock position on the hour-circle. The first colour of the first sensor may be chosen to be identical to or different from the first colour of the second sensor.

If they are identical, it is advantageous to have 12 discs 120, one per hour, and it is advantageous to have different second colours. For example, the first colour of the first and of the second sensor will be white; the first sensor for the depth measurement will have a second colour which will be blue, whereas the second sensor for the altitude measurement will have a second colour which will be red.

In a second embodiment seen in FIGS. 5 and 6, the external element is the crystal 108 of the portable object. This crystal 108 is secured to case middle 104 and has a top face 108a, a bottom face 108b and a lateral edge 108c for attachment.

In this second embodiment, piezochromic discs 122 are arranged on the top face 108a of the crystal.

In the case of an ink or a paint, the discs are silk-screen printed on said top face 108a. A scale may also be silk-screen printed to associate a number indication with these piezochromic discs. This scale may be silk-screen printed on the bezel.

In a variant, the crystal has hollows 108d of very small thickness. These hollows allow the piezochromic ink to be placed therein while ensuring a perfectly smooth surface of crystal 108, thereby reducing the risk of said ink being chipped off by shocks.

In the case where discs 122 take the form of inserts, the top face 108a of crystal 108 includes hollows 108d. The number of hollows is identical to the number of inserts. The inserts can then be placed and secured in the hollows by adhesive bonding, for example. However, it is also possible to over-mould the inserts in the hollows. A crystal with a bimaterial appearance is thus obtained.

It is possible, in both cases, for piezochromic discs 122 to be arranged on the top face of the crystal but for the depth or altitude indicator numbers to be placed on the dial or underneath the crystal.

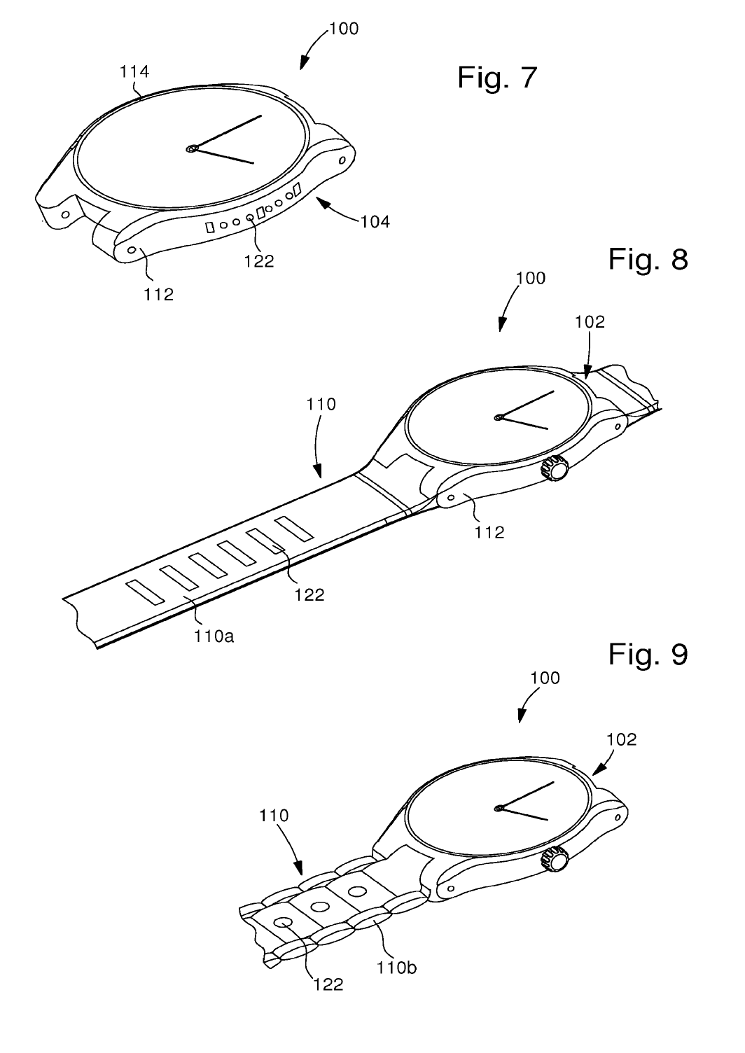

In a third embodiment visible in FIG. 7, exterior element 30 is the case middle 104 of the portable object.

As for the first and second embodiment, piezochromic discs 122 in the form of ink or inserts are arranged directly on the case middle or in the hollows in said case middle. The depth indicator numbers may be silk-screen printed on the case middle.

In a fourth embodiment, the external element is the watchband 110. Indeed, the timepiece is provided with a watchband secured to the case middle via two pairs of horns.

In a first case seen in FIG. 8, watchband 110 is formed of two watchband strands 110a, each strand being secured to a pair of horns 112 and connected to the other strand via a clasp 111. Preferably, watchband strands 110a are made of rubber or plastic.

There are several possible solutions for the arrangement of piezochromic discs 122.

A first solution consists in silk-screen printing the watchband with a piezochromic ink or in coating certain areas with a piezochromic paint; this operation can be performed on a leather, plastic, metal or plastic watchband.

A second solution consists in using discs as inserts and placing and securing these inserts in hollows made in the watchband link.

A third solution consists in silk-screen printing a flexible support with the piezochromic ink. This flexible support is then inserted in the watchband link so that the discs are visible.

In a second case visible in FIG. 9, the watchband is made of metal and is then formed of a plurality of links 110b attached to each other by means of pins. This makes it possible to obtain links 110b which can pivot with respect to each other.

This watchband strand also comprises a clasp. The clasp is shown here in the form of a deployant buckle 111.

Piezochromic discs 122 in the form of ink or inserts are then arranged in links 110b of said watchband, directly on the watchband or in hollows therein.

Preferably, each link 110b carries a piezochromic disc.

Even more preferably, piezochromic discs 122 are arranged on the links 100c located between the pair of horns at 6 o'clock and the deployant buckle. Indeed, when a timepiece is on the user's wrist, the links 110b located between the pair of horns at 6 o'clock and deployant buckle 111 are the most accessible to the user. The user only needs to turn his wrist slightly to see them. They are even more visible when the user's arms are placed on a table or a desk. This arrangement avoids overloading the visual display on the dial by having discs on the crystal or the bezel while still offering good visibility.

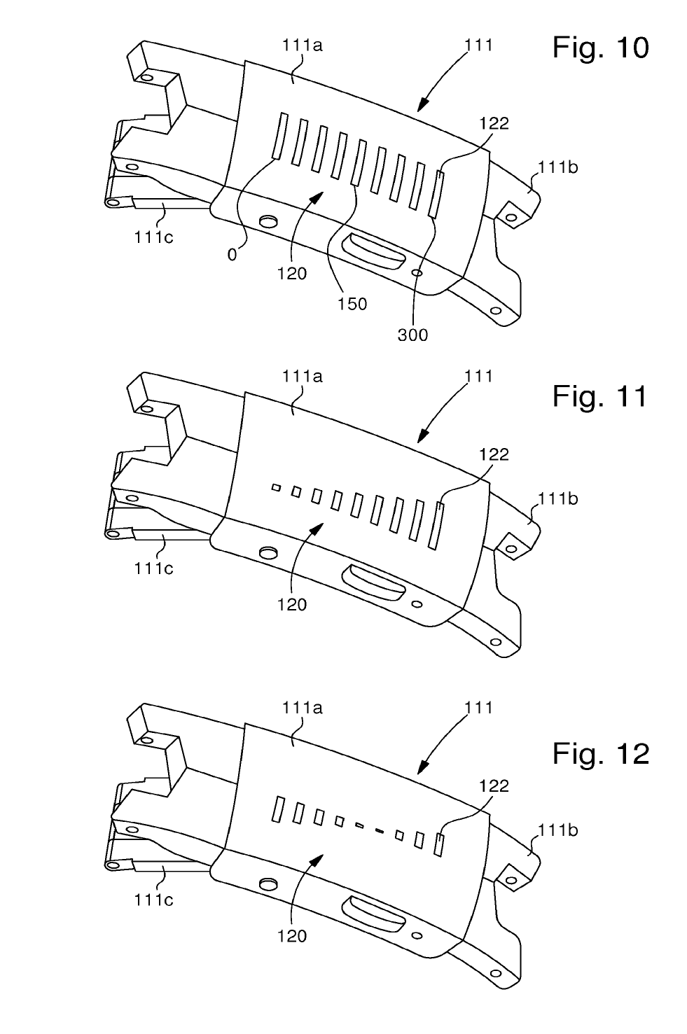

In a fourth embodiment visible in FIGS. 10 to 12, the external element is clasp 111, i.e. the deployant buckle of the watchband. This deployant buckle is generally formed of three parts 111a, 111b, 111c such as longitudinal bars hinged to each other. Two of these parts are secured to a link. These parts forming deployant buckle 111 are thus devised to be hinged to each other such that they can lie one atop the other, these three parts 111a, 111b, 111c then forming one part. This configuration makes it possible to lengthen the watchband momentarily for attachment to the user's wrist.

For some deployant buckle models, one of the parts acts as the main part 111a, since it is this part that accommodates the other two parts 111b, 111c, this main part 111a is the part visible from the exterior. From the exterior, the user therefore sees one part taking the form of a metal plate on which markings, such as the brand name, can be engraved.

Advantageously, the present invention uses this surface for arranging the altitude sensor. Piezochromic discs 122 are thus disposed on this surface on the central part 11a of the deployant buckle as seen in FIG. 10.

Piezochromic discs 122 may be aligned and associated with a scale of number indications. It is, however, possible for discs 122 to be configured to have different sizes according to altitude as seen in FIG. 11. For example, piezochromic discs 122 may take the form of bars that become larger as the depth increases or as the altitude increases. It is therefore possible, without any number indications, for the user to obtain reliable information.

In a variant seen in FIG. 12, it is be possible to have an extended scale. This extended scale has a central line from which the bars forming piezochromic bars 122 extend. These bars extend on both sides of the line such that the bars used for depth measurement extend downwards, whereas the bars for altitude measurement extend upwards.

In a variant of the invention, the piezochromic pigment is coupled to a fluorescent pigment to emit a more intense colour in the presence of ultraviolet rays or to a phosphorescent pigment to absorb the visible spectrum energy and to emit an intense colour in the absence of light.

This feature allows piezochromic disc 122 to be luminescent and visible to the user in all circumstances. For example, this ability to react to ultraviolet or visible light makes it possible to obtain discs that readable during a deep sea dive in a dark medium.

It will be clear that various alterations and/or improvements and/or combinations evident to those skilled in the art may be made to the various embodiments of the invention set out above without departing from the scope of the invention defined by the annexed claims.

It is also possible for the timepiece crown to have at least one piezochromic disc. This disc may be configured such that the pressure at which it changes colour corresponds to the maximum altitude or depth of said timepiece.

What is claimed is:

1. External timepiece element including a frame made of a first material, said external element further including at least one pressure sensor, wherein said pressure sensor is formed of at least one plate, said plate being formed of or coated with a binder and a piezochromic pigment, said piezochromic pigment being selected to react at a specific pressure, so that said pigment changes from a first colour to a second colour when said specific pressure is reached.

2. External element according to claim 1, wherein said pressure sensor is formed of a plurality of plates, each plate reacting at a specific pressure that is peculiar thereto.

3. External element according to claim 2, wherein said plates all have the same first colour.

4. External element according to claim 3, wherein said plates all have the same second colour.

5. External element according to claim 3, wherein said plates are devised such that the second colour can produce shading when the plates have all changed from the first colour to the second colour.

6. External element according to claim 1, wherein said pressure sensor allows measurement of a positive altitude with respect to sea level.

7. External element according to claim 1, wherein said pressure sensor allows measurement of a negative altitude with respect to sea level.

8. External element according to claim 1, wherein said pressure sensor allows measurement of an underwater depth.

9. External element according to claim 1, wherein the plate takes the form of an ink or paint or lacquer deposited on the frame, said frame being hollow and having a known pressure.

10. External element according to claim 1, wherein the plate takes the form of an insert formed of a hollow body impermeable to water and air, said hollow body being coated by said piezochromic pigment.

11. External element according to claim 1, wherein the plate takes the form of an insert formed of a hollow body impermeable to water and air, said piezochromic pigment being dispersed in the material forming said body.

12. External element according to claim 1, wherein the frame includes at least one hollow in which the plate is arranged.

13. External element according to claim 1, wherein the frame is a bezel.

14. External element according to claim 1, wherein the frame is a crystal.

15. External element according to claim 1, wherein the frame is a middle part of a watch case.

16. External element according to claim 1, wherein the frame is a watchband.

17. External element according to claim 16, wherein the watchband includes two strands, said pressure sensor being arranged on at least one of the two strands.

18. External element according to claim 16, wherein the watchband includes a plurality of links hinged to each other, said pressure sensor being arranged on at least one link.

19. External element according to claim 16, wherein said watchband is closed by a clasp with a deployant buckle, said pressure sensor being arranged on said clasp.

20. External element according to claim 1, wherein the frame is a crown.

21. External element according to claim 1, wherein said piezochromic pigment is coupled to a luminescent pigment to emit a more intense colour.
